(19) United States
(12) Patent Application Publication
(10) Pub. No.: US 2026/0098485 A1
(43) Pub. Date: Apr. 9, 2026

(54) POWERPLANT JACKING INSERT WITH EXTERIOR AND INTERIOR THREADS

(71) Applicant: Pratt & Whitney Canada Corp., Longueuil (CA)

(72) Inventors: Guy Lefebvre, St-Bruno (CA); Daniel Lecuyer, St-Bruno-De-Montarville (CA)

(21) Appl. No.: 18/909,569

(22) Filed: Oct. 8, 2024

(51) Int. Cl. F01D 25/24

(52) U.S. Cl. CPC F01D 25/243; F05D 2220/32; F05D 2230/60; F05D 2240/14

(57) ABSTRACT

An assembly is provided for a powerplant. This powerplant assembly includes a first powerplant component, a second powerplant component, a plurality of fasteners and an insert. The first powerplant component includes a first component mount and a plurality of first component apertures. The first component apertures are arranged circumferentially about an axis and extend axially through the first component mount. The first component apertures include a plurality of first component fastener apertures and a first component insert aperture. The second powerplant component includes a second component mount and a plurality of second component fastener apertures. The fasteners attach the first component mount and the second component mount together. Each of the fasteners is mated with a respective one of the first component fastener apertures and a respective one of the second component fastener apertures. The insert is threaded into the first component insert aperture. The insert includes a threaded bore.

### TECHNICAL FIELD

This disclosure relates generally to a powerplant and, more particularly, to a mechanical joint between powerplant components.

### BACKGROUND INFORMATION

A stationary structure for a powerplant such as a gas turbine engine may include a plurality of engine cases connected together at a mechanical joint such as a bolted flange joint. Various types of mechanical joints are known in the art, and various techniques for disassembling such mechanical joints are known in the art. While these known mechanical joints and associated disassembly techniques have various benefits, there is still room in the art for improvement.

### SUMMARY

According to an aspect of the present disclosure, an assembly is provided for a powerplant. This powerplant assembly includes a first powerplant component, a second powerplant component, a plurality of fasteners and an insert. The first powerplant component includes a first component mount and a plurality of first component apertures. The first component apertures are arranged circumferentially about an axis and extend axially through the first component mount. The first component apertures include a plurality of first component fastener apertures and a first component insert aperture. The second powerplant component includes a second component mount and a plurality of second component fastener apertures. Each of the second component fastener apertures is aligned with a respective one of the first component fastener apertures. The fasteners attach the first component mount and the second component mount together. Each of the fasteners is mated with a respective one of the first component fastener apertures and a respective one of the second component fastener apertures. The insert is threaded into the first component insert aperture. The insert includes a threaded bore.

According to another aspect of the present disclosure, another assembly is provided for a powerplant. This powerplant assembly includes a first powerplant component, a second powerplant component, a plurality of fasteners and an insert. The first powerplant component includes a first flange and a plurality of first component apertures. The first component apertures are arranged circumferentially about an axis and extend axially through the first flange. The first component apertures include a plurality of first component fastener apertures and a first component insert aperture. The second powerplant component includes a second flange and a plurality of second component fastener apertures. The second flange axially engages the first flange. Each of the second component fastener apertures is aligned with a respective one of the first component fastener apertures. The fasteners attach the first flange and the second flange together. Each of the fasteners includes a shank projecting axially through a respective one of the first component fastener apertures and a respective one of the second component fastener apertures. The insert projects axially through the first component insert aperture and is fixed to the first flange through a threaded interface. The insert includes a threaded bore extending axially through the insert.

According to still another aspect of the present disclosure, an apparatus is provided for a turbine engine. This turbine engine apparatus includes a jacking insert. The jacking insert includes a head, a shank, a bore, exterior threads and interior threads. The shank projects axially along a centerline axis of the jacking inserted out from the head to a distal end of the jacking insert. The bore projects axially along the centerline axis through the head and the shank. The exterior threads are arranged along an exterior of the shank. The exterior threads are configured with a first rotational thread direction about the centerline axis of the insert. The interior threads are arranged along the bore. The interior threads are configured with a second rotational thread direction about the centerline axis of the insert that is opposite the first rotational thread direction.

An outer peripheral geometry of the head may be polygonal.

The threaded bore may be configured to be empty during powerplant operation.

The second component mount may include a second component mating surface radially and circumferentially overlapping the threaded bore. Each of the second component fastener apertures may project into the second component mount from the second component mating surface.

The first component mount may include a first component mating surface axially engaging the second component mating surface. Each of the first component apertures may project into the first component mount from the first component mating surface.

The second component mount may radially and circumferentially cover the threaded bore.

The first component mount may axially contact the second component mount.

The first component mount may radially contact the second component mount.

Exterior threads may be threaded into the first component insert aperture. The exterior threads may be configured with a first rotational thread direction about a centerline axis of the insert. Interior threads may be provided along the threaded bore. The interior threads may be configured with a second rotational thread direction about the centerline axis of the insert that is opposite the first rotational thread direction.

The insert may include a head and a shank. The head may be abutted axially against the first component mount. The shank may project out from the head to a distal end of the insert. The shank may be threaded into the first component insert aperture.

The head may be disposed axially between the first component mount and the second component mount.

The head may be seated in a pocket in the first component mount.

The head may be disposed in a pocket in the second component mount.

The head may include a wrenching feature.

The shank may include a wrenching feature.

Each of the first component fastener apertures may be an unthreaded through-hole.

Each of the second component fastener apertures may be an unthreaded through-hole.

Each of the fasteners may include a head and a shank. The head may be abutted axially against the first component mount. The shank may project axially out from the head, through a respective one of the first component fastener apertures and a respective one of the second component fastener apertures, to a distal end of the shank. The shank may be mated with a nut at the distal end of the shank. The nut may be abutted axially against the second component mount.

The powerplant may be configured as an aircraft engine. The first powerplant component may be configured as a first engine case. The second powerplant component may be configured as a second engine case.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of an aircraft powerplant with an intermittent internal combustion engine.

FIG. 2 is a partial schematic illustration of the aircraft powerplant with a gas turbine engine.

FIG. 3 is a partial illustration of a stationary structure at a mechanical joint.

FIG. 4 is a partial side sectional illustration of the stationary structure at line 4-4 in FIG. 3.

FIG. 5 is a partial side sectional illustration of the stationary structure at line 5-5 in FIG. 3.

FIG. 6 is a partial end-view illustration of a first powerplant component.

FIG. 7 is a partial end-view illustration of a second powerplant component.

FIGS. 8 and 9 are perspective illustrations of a threaded insert.

FIGS. 10A and 10B illustrate a sequence for disassembling the powerplant components.

FIG. 11 is a partial side sectional illustration of the stationary structure with another insert pocket arrangement.

FIGS. 12 and 13 are perspective illustrations of the threaded insert with another wrenching feature.

FIGS. 14 and 15 are perspective illustrations of the threaded insert with still another wrenching feature.

### DETAILED DESCRIPTION

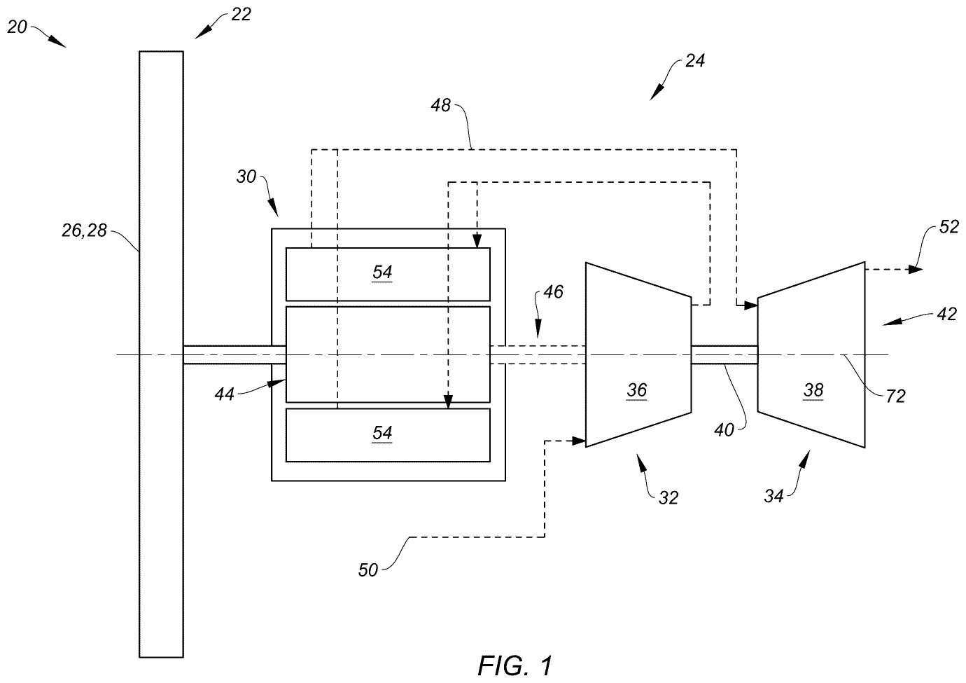

FIG. 1 illustrates a powerplant 20 for an aircraft. The aircraft may be an airplane, a helicopter, a drone (e.g., an unmanned aerial vehicle (UAV)) or any other manned or unmanned aerial vehicle or system. The powerplant 20 may be configured as, or otherwise included as part of, a propulsion system for the aircraft. The powerplant 20 may also or alternatively be configured as, or otherwise included as part of, an electrical power system for the aircraft. The present disclosure, however, is not limited to aircraft applications. The powerplant 20, for example, may alternatively be configured as, or otherwise included as part of, an electrical power system for ground-based operation (e.g., an industrial powerplant), or otherwise. However, for ease of description, the powerplant 20 is described below as an aircraft powerplant.

The aircraft powerplant 20 of FIG. 1 includes a mechanical load 22 powered by an engine system 24. The mechanical load 22 may be configured as or otherwise include a rotor 26 mechanically driven by the engine system 24. This driven rotor 26 may be a bladed propulsor rotor for the aircraft propulsion system. The propulsor rotor may be an open propulsor rotor (e.g., an un-ducted propulsor rotor) or a ducted propulsor rotor. For example, where the engine system 24 is a propeller engine (e.g., a turbocharged propeller engine, a turbo-compound propeller engine or a turboprop engine), the open propulsor rotor may be a propeller rotor 28. Where the engine system 24 is a turboshaft engine, the open propulsor rotor may be a rotorcraft rotor such as a helicopter main rotor or a helicopter tail rotor. Where the engine system 24 is a turbofan engine, the ducted propulsor rotor may be a fan rotor. Alternatively, the driven rotor 26 may be configured as a generator rotor of an electric power generator for the aircraft electrical power system; e.g., an auxiliary power unit (APU) system. The present disclosure, however, is not limited to the foregoing exemplary mechanical loads nor to the foregoing exemplary engine systems. The engine system 24, for example, may alternatively be configured as a turbojet engine, a propfan engine, a pusher fan engine or any other type of turbine engine operable to power the operation of the mechanical load 22. However, for ease of description, the driven rotor 26 is described below as the propeller rotor 28.

The engine system 24 may be configured as a turbocharged or turbo-compound engine. The engine system 24 of FIG. 1, for example, includes an intermittent internal combustion (IC) engine 30, a compressor section 32 (e.g., an engine compressor) and a turbine section 34 (e.g., an engine turbine). The internal combustion engine 30 may be configured as a reciprocating piston engine or a rotary engine. Examples of the reciprocating piston engine include, but are not limited to, a radial engine, an inline (I) engine, a V-engine and a W-engine. A non-limiting example of the rotary engine is a Wankel engine. The compressor section 32 includes a bladed compressor rotor 36. The turbine section 34 includes a bladed turbine rotor 38. This turbine rotor 38 is coupled to and rotatable with the compressor rotor 36. The turbine rotor 38 of FIG. 1, for example, is connected to the compressor rotor 36 through a shaft 40. At least (or only) a combination of the compressor rotor 36, the turbine rotor 38 and the shaft 40 may collectively form a turbo-compressor rotating assembly 42; e.g., a spool. This turbo-compressor rotating assembly 42 may be rotationally discrete from an internal rotating assembly 44 of the internal combustion engine 30. Alternatively, the turbo-compressor rotating assembly 42 may be operatively coupled to and rotatable with the engine rotating assembly 44 through a drivetrain 46 (see dashed line). This drivetrain 46 may be a direct drive drivetrain or a geared drivetrain.

The aircraft powerplant 20 and its engine system 24 include an internal powerplant flowpath 48. This powerplant flowpath 48 extends from an inlet 50 into the aircraft powerplant 20 and its engine system 24 to a combustion products exhaust 52 from the aircraft powerplant 20 and its engine system 24. More particularly, the powerplant flowpath 48 extends sequentially through the compressor section 32, through one or more combustion zones 54 (e.g., cylinder chambers, etc.) within the internal combustion engine 30, and through the turbine section 34 from the flowpath inlet 50 to the flowpath exhaust 52. With this arrangement, air delivered to the internal combustion engine 30 is compressed by the compressor rotor 36, and combustion products produced by combustion of a mixture of the compressed air and fuel within the combustion zone(s) 54 drives rotation of the engine rotating assembly 44 and the turbine rotor 38. The rotation of the engine rotating assembly 44 drives rotation of the propeller rotor 28—the driven rotor 26. The rotation of the turbine rotor 38 drives rotation of the compressor rotor 36 to facilitate the compression of the incoming air to the internal combustion engine 30. The rotation of the turbine rotor 38 may also assist driving rotation of the engine rotating assembly 44 where the turbo-compressor rotating assembly 42 is coupled to the engine rotating assembly 44 through the optional direct drive or geared drivetrain 46.

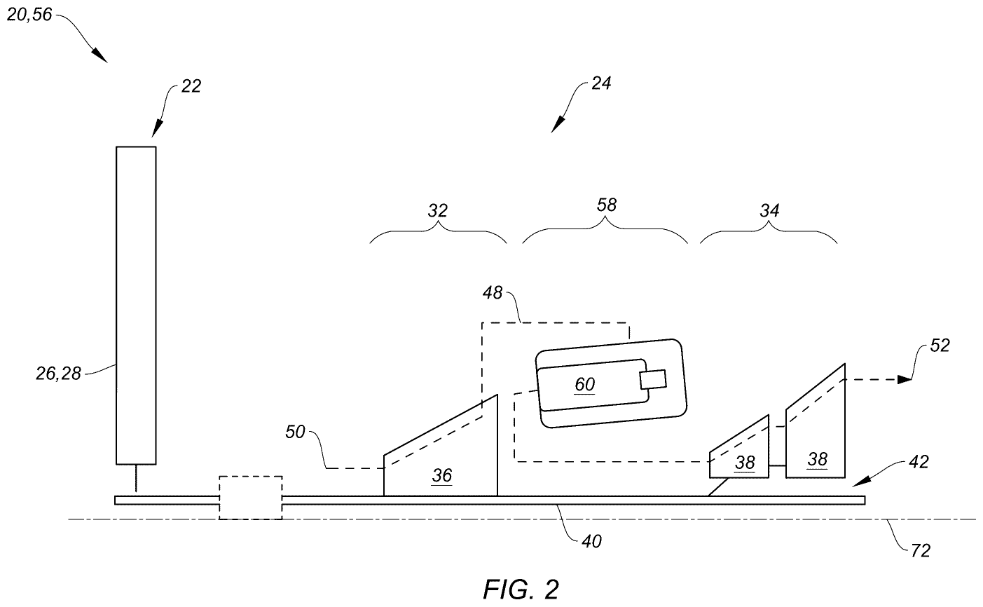

While the engine system 24 is described above as including the internal combustion engine 30 fluidly coupled between the compressor section 32 and the turbine section 34, the aircraft powerplant 20 of the present disclosure is not limited to such an exemplary arrangement as described above. For example, referring to FIG. 2, the engine system 24 may alternatively be configured as a gas turbine engine 56 where the internal combustion engine 30 of FIG. 1 is replaced by a combustor section 58 of FIG. 2. With such an arrangement, the powerplant flowpath 48 extends sequentially through the compressor section 32, through a combustion chamber 60 (e.g., an annular combustion chamber) within the combustor section 58, and through the turbine section 34 from the flowpath inlet 50 to the flowpath exhaust 52. For ease of illustration, the turbine engine 56 of FIG. 2 is shown as a single spool turbine engine. It is contemplated, however, the turbine engine 56 may alternatively include two or more spools; e.g., two or more internal rotating assemblies.

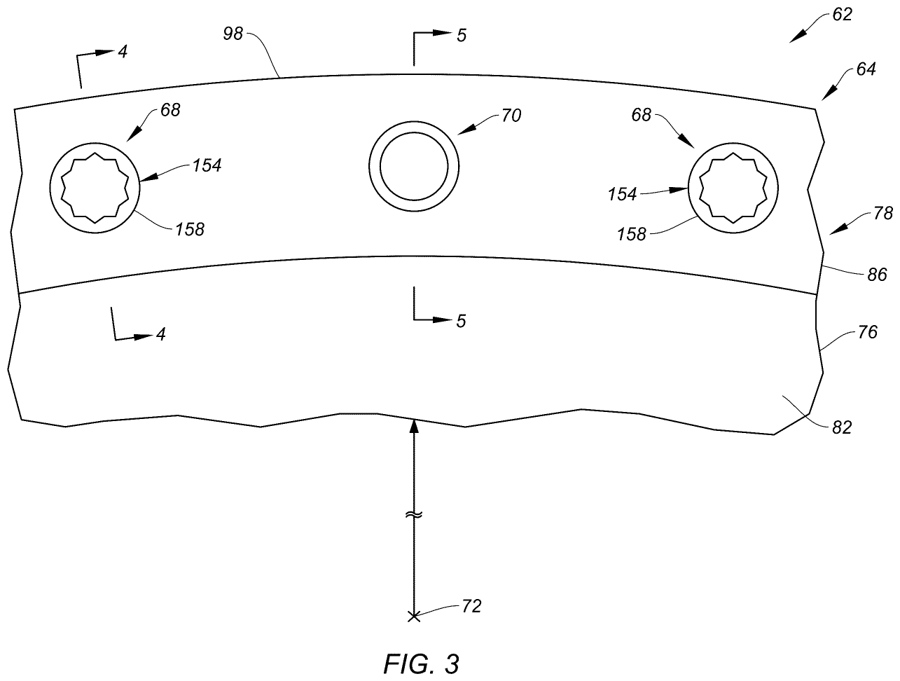

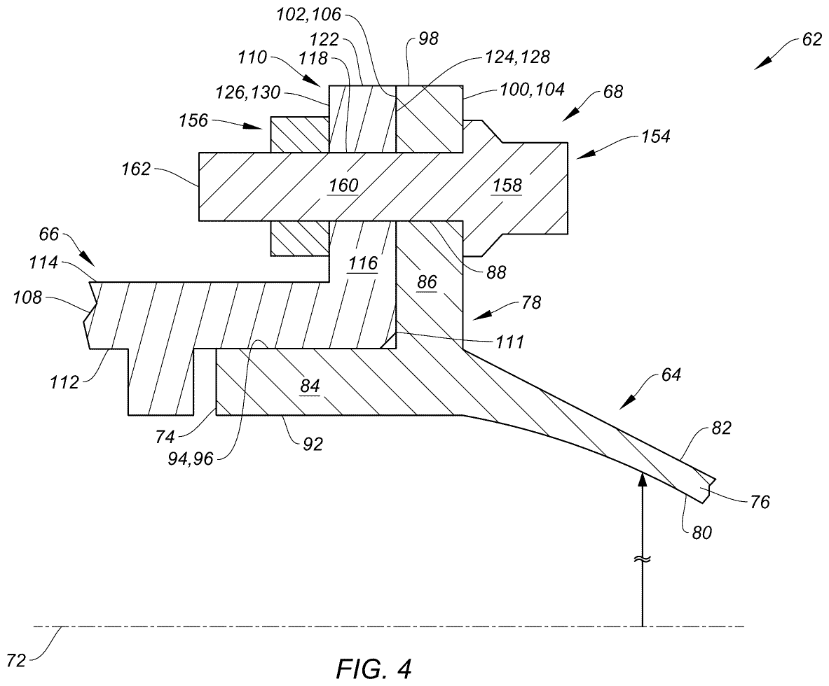

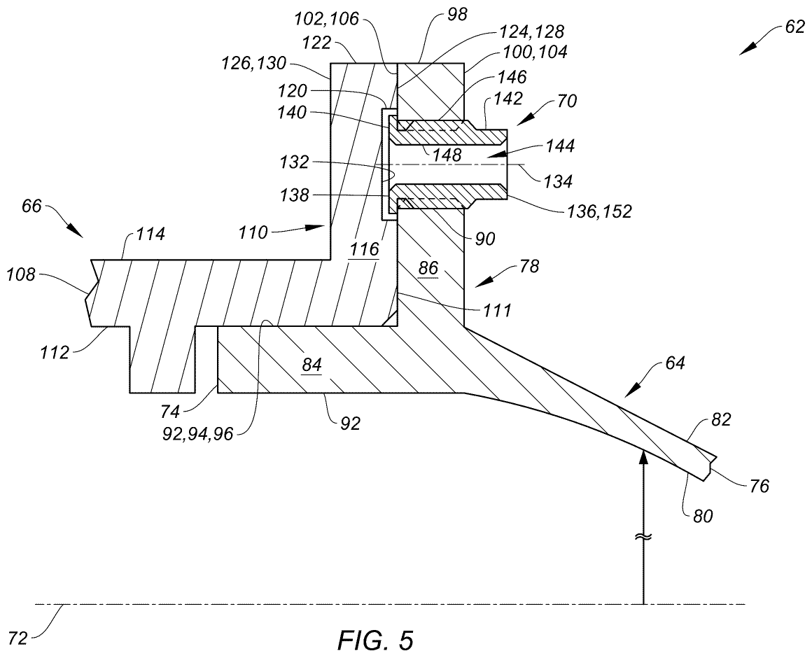

FIGS. 3-5 illustrate portions of a stationary structure 62 for the aircraft powerplant 20 and its engine system 24 of FIG. 1 or 2. This stationary structure 62 is configured to partially or completely house various components of the engine system 24 of FIG. 1 or 2. The stationary of FIGS. 3-5, for example, is configured as or otherwise includes an engine housing; e.g., an engine casing. Referring to FIGS. 3 and 4, the stationary structure 62 includes a first powerplant component 64, a second powerplant component 66 and a plurality of fastener assemblies 68 for securing the first powerplant component 64 and the second powerplant component 66 together. Referring to FIGS. 3 and 5, the stationary structure 62 also includes one or more exterior-interior threaded inserts 70; e.g., jacking inserts.

The first powerplant component 64 of FIGS. 4 and 5 may be configured as a tubular engine case and/or support structure for the aircraft powerplant and its engine system. The first powerplant component 64, for example, may be configured as a turbine exhaust case (TEC) for the engine system. The first powerplant component 64 extends axially along an axis 72 of the powerplant component(s) 64 and 66 to an axial end 74 of the first powerplant component 64. Briefly, this component axis 72 may be a centerline axis of the first powerplant component 64 and/or a centerline axis of the first powerplant component 64. More generally, the component axis 72 may also or alternatively be a centerline axis of the stationary structure 62 and/or the engine system 24 (see FIGS. 1 and 2). The first powerplant component 64 includes a first component base 76 and a first component mount 78.

The first component base 76 of FIGS. 4 and 5 extends axially along the component axis 72 to the first component mount 78. The first component base 76 extends radially from a radial inner side 80 of the first component base 76 to a radial outer side 82 of the first component base 76. The first component base 76 extends circumferentially about (e.g., completely around) the component axis 72, providing the first component base 76 with a full-hoop (e.g., tubular) geometry around the component axis 72.

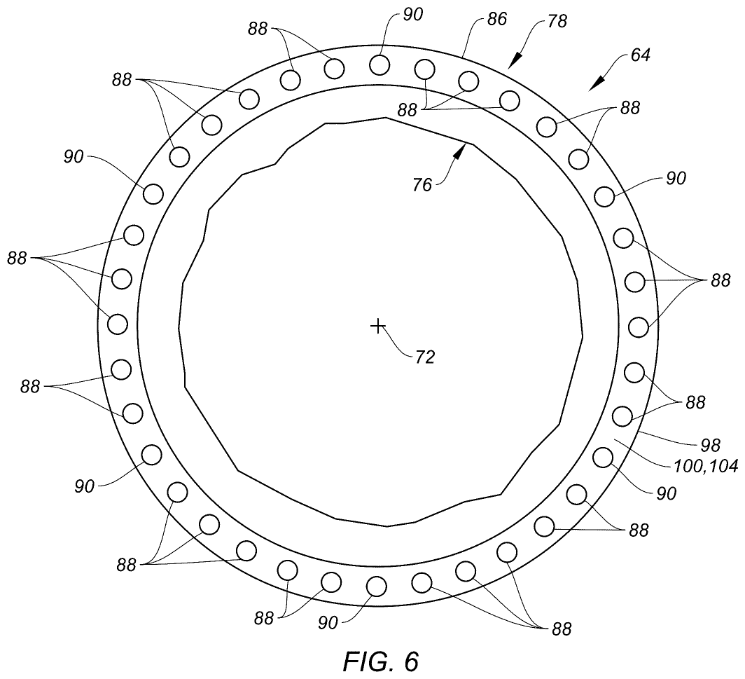

The first component mount 78 is connected to (e.g., formed integrally with or otherwise attached to) the first component base 76. The first component mount 78 is disposed at (e.g., on, adjacent or proximate) the first component end 74. The first component mount 78 of FIGS. 4 and 5, for example, projects axially along the component axis 72 out from the first component base 76 to the first component end 74. This first component mount 78 includes a first component rim 84 and a first component flange 86. The first component mount 78 also includes one or more first component fastener apertures 88 and one or more first component insert apertures 90; see also FIG. 6.

The first component rim 84 projects axially along the component axis 72 out from the first component base 76 to the first component end 74. The first component rim 84 extends radially from a radial inner side 92 of the first component mount 78 to a radial outer side 94 of the first component rim 84. Here, the mount inner side 92 and the base inner side 80 may collectively form a radial inner side of the first powerplant component 64. The first component rim 84 extends circumferentially about (e.g., completely around) the component axis 72, providing the first component rim 84 with a full-hoop (e.g., tubular) geometry around the component axis 72. At the rim outer side 94, the first component rim 84 may include a regular cylindrical outer mating surface 96 parallel to the component axis 72.

The first component flange 86 of FIGS. 4 and 5 is axially setback from the first component end 74, for example at an axial interface between the first component mount 78 and the first component base 76. The first component flange 86 projects radially outward (e.g., radially away from the component axis 72) from (a) the first component rim 84 at its rim outer side 94 and/or (b) the first component base 76 at its base outer side 82 to a radial outer distal end 98 of the first component flange 86. The first component flange 86 extends axially along the component axis 72 and the first component rim 84 between and to opposing axial sides 100 and 102 of the first component flange 86. At the flange first side 100, the first component flange 86 may include an annular exterior surface 104 with, for example, a flat planar geometry perpendicular to the component axis 72. At the flange second side 102, the first component flange 86 may include an annular interior mating surface 106 with, for example, a flat planar geometry perpendicular to the component axis 72.

Referring to FIG. 6, the first component apertures 88 and 90 are arranged and may (or may not) be equispaced circumferentially about the component axis 72 in an array; e.g., a circular array. Here, center points of the first component apertures 88 and 90 may be disposed at common (e.g., identical) radial distances from the component axis 72. Within the array of the first component apertures 88 and 90, the first component fastener apertures 88 may be arranged in one or more sets; e.g., groupings of one or more of the first component fastener apertures 88. These first component fastener aperture sets may be circumferentially interposed with the first component insert apertures 90, and vice versa, about the component axis 72. For example, each first component fastener aperture set may be located circumferentially between a circumferentially neighboring (e.g., adjacent) pair of the first component insert apertures 90. Similarly, each first component insert aperture 90 may be located circumferentially between a circumferentially neighboring pair of the first component fastener aperture sets.

Referring to FIG. 4, each first component fastener aperture 88 extends axially through the first component mount 78 and, more particularly, the first component flange 86 between the opposing axial sides 100 and 102 of the first component flange 86. Each first component fastener aperture 88 of FIG. 4 is configured as an unthreaded through holes with, for example, a regular cylindrical geometry.

Referring to FIG. 5, each first component insert aperture 90 extends axially through the first component mount 78 and, more particularly, the first component flange 86 between the opposing axial sides 100 and 102 of the first component flange 86. Each first component insert aperture 90 of FIG. 5 is configured as a threaded through hole.

The second powerplant component 66 of FIGS. 4 and 5 may be configured as a tubular engine case and/or support structure for the aircraft powerplant 20 and its engine system 24. The second powerplant component 66, for example, may be configured as a turbine case for the engine system 24. The second powerplant component 66 extends axially along the component axis 72 to an axial end 111 of the second powerplant component 66. The second powerplant component 66 includes a second component base 108 and a second component mount 110.

The second component base 108 of FIGS. 4 and 5 extends axially along the component axis 72 to the second component mount 110. The second component base 108 extends radially from a radial inner side 112 of the second component base 108 to a radial outer side 114 of the second component base 108. The second component base 108 extends circumferentially about (e.g., completely around) the component axis 72, providing the second component base 108 with a full-hoop (e.g., tubular) geometry around the component axis 72.

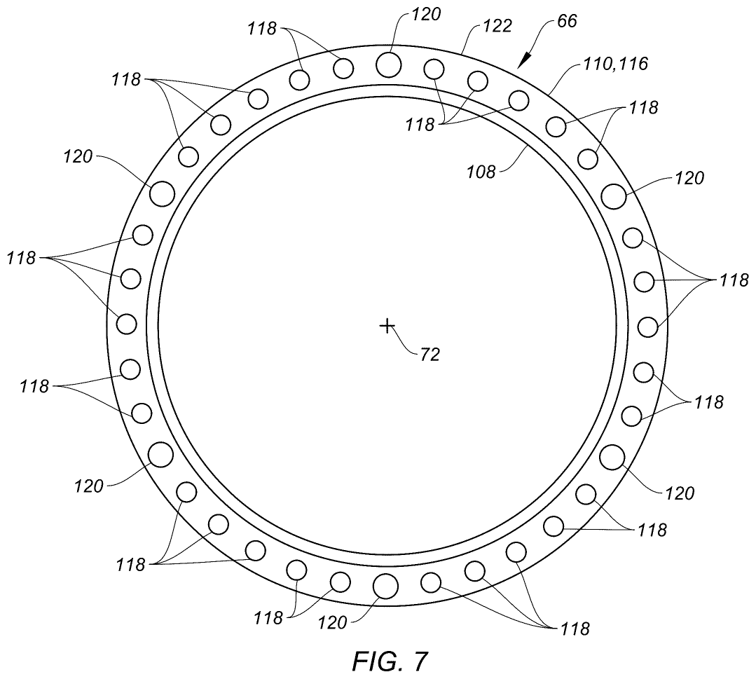

The second component mount 110 is connected to (e.g., formed integrally with or otherwise attached to) the second component base 108. The second component mount 110 is disposed at the second component end 111. The second component mount 110 of FIG. 4 includes a second component flange 116 and one or more second component fastener apertures 118; see also FIG. 7. The second component mount 110 of FIG. 5 may also include one or more second component insert pockets 120; see also FIG. 7.

The second component flange 116 of FIGS. 4 and 5 is located at and may partially or completely define the second component end 111. The second component flange 116 projects radially outward from a radial inner side of the second component mount 110 to a radial outer distal end 122 of the second component flange 116. The second component flange 116 extends axially along the component axis 72 between and to opposing axial sides 124 and 126 of the second component flange 116. At the flange first side 124, the second component flange 116 may include an annular interior mating surface 128 with, for example, a flat planar geometry perpendicular to the component axis 72. At the flange second side 126, the second component flange 116 may include an annular exterior surface 130 with, for example, a flat planar geometry perpendicular to the component axis 72.

Referring to FIG. 7, the second component fastener apertures 118 are arranged circumferentially about the component axis 72 in an array; e.g., a circular array. A pattern of the second component fastener apertures 118 in this array matches (e.g., is the same as, is identical to) a pattern of the first component fastener apertures 88 in FIG. 6. Referring to FIG. 4, each second component fastener aperture 118 extends axially through the second component mount 110 and, more particularly, the second component flange 116 between the opposing axial sides 124 and 126 of the second component flange 116. Each second component fastener aperture 118 of FIG. 4 is configured as an unthreaded through holes with, for example, a regular cylindrical geometry.

Referring to FIG. 7, the second component insert pockets 120 are arranged circumferentially about the component axis 72 in an array; e.g., a circular array. A pattern of the second component insert pockets 120 in this array matches a pattern of the first component insert apertures 90 in FIG. 6. Referring to FIG. 5, each second component insert pocket 120 is configured as a blind aperture. Each second component insert pocket 120 of FIG. 5, for example, projects partially axially into the second component mount 110 and, more particularly, the second component flange 116 from the flange first side 124 and its second component interior mating surface 128 to an axial distal end 132 of the respective second component insert pocket 120. Each second component insert pocket 120 extends radially and circumferentially within the second component mount 110 and its second component flange 116; see also FIG. 7.

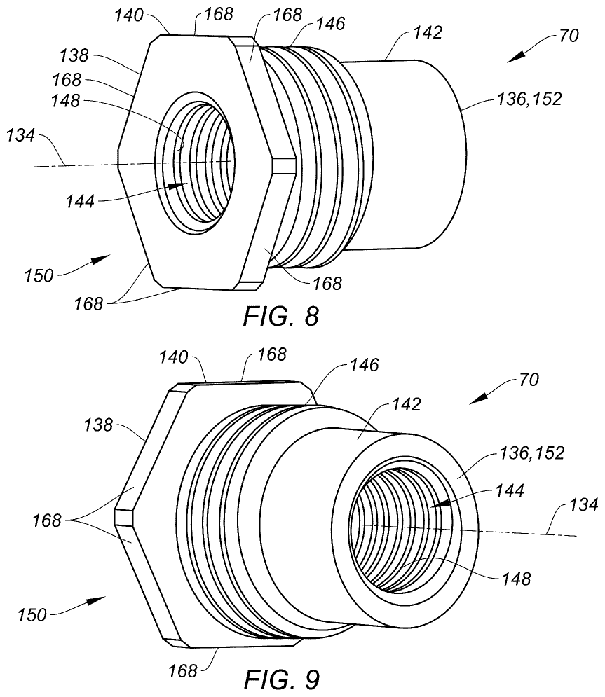

Referring to FIGS. 8 and 9, each threaded insert 70 extends axially along a centerline axis 134 of the respective threaded insert 70 between and to opposing axial ends 136 and 138 of the respective threaded insert 70. Here, the insert axis 134 is parallel to the component axis 72; see FIG. 5. Each threaded insert 70 includes an insert head 140, a tubular insert shank 142 and an insert bore 144. Each threaded insert 70 also includes exterior threads 146 and interior threads 148.

The insert head 140 is disposed at the insert second end 138. This insert head 140 may be configured with a wrenching feature 150. An outer peripheral geometry of the insert head 140, for example, may have a polygonal shape when viewed in a reference plane perpendicular to the respective insert axis 134. More particularly, in FIGS. 8 and 9, the insert head 140 is provided with a hexagonal shaped outer peripheral geometry. Note, while corners of the insert head 140 along its outer peripheral geometry are eased (e.g., chamfered, or alternatively radiused), it is contemplated one or more of these corners may alternatively be pointed; e.g., non-eased. Moreover, while the insert head 140 is provided in FIGS. 8 and 9 with the hexagonal shaped outer peripheral geometry, the present disclosure is not limited to such an exemplary polygonal shape. Examples of other suitable polygonal shapes for the outer peripheral geometry include, but are not limited to, square, 12-point shaped, etc.

The insert shank 142 is connected to (e.g., formed integral with or otherwise attached to) the insert head 140. This insert shank 142 projects axially out from the insert head 140 along the respective insert axis 134 to an axial distal end 152 of the insert shank 142 at the insert first end 136.

The insert bore 144 extends axially along the respective insert axis 134 through the respective threaded insert 70 from the insert first end 136 to the insert second end 138. More particularly, the insert bore 144 extends axially from the insert first end 136, respectively through the insert shank 142 and the insert head 140, to the insert second end 138. With this arrangement, the insert head 140 is provided is an annular geometry and the insert shank 142 is provided with a tubular geometry.

The exterior threads 146 are disposed to a radial outer side of the insert shank 142. These exterior threads 146 may wrap and extend along an axial portion of the insert shank 142 next to the insert head 140. Alternatively, the exterior threads 146 may wrap and extend along the insert shank 142 from (or about) the insert head 140 to (or about) the shank distal end 152. These exterior threads 146 are configured with a first rotational thread direction (e.g., a clockwise thread direction, or a counterclockwise thread direction) about the respective insert axis 134.

The interior threads 148 are disposed to a radial inner side of the respective threaded insert 70 and its members 140 and 142. These interior threads 148 wrap around the respective insert axis 134 and extend along a portion or an entirety of an axial extent of the respective threaded insert 70. The interior threads 148 of FIGS. 8 and 9, for example, extend from (or about) the shank distal end 152, along the insert shank 142 and the insert head 140, to (or about) the insert second end 138. These interior threads 148 are configured with a second rotational thread direction (e.g., the counterclockwise thread direction, or the clockwise thread direction) about the respective insert axis 134, where the second rotational thread direction for the interior threads 148 is opposite the first rotational thread direction for the exterior threads 146.

Referring to FIG. 5, each threaded insert 70 is mated with a respective first component insert aperture 90. The insert shank 142 and its exterior threads 146, for example, are threaded into a respective first component insert aperture 90 until an axial first side of the insert head 140 axially abuts against, axially contacts and/or otherwise axially engages the first component flange 86 and its first component interior mating surface 106. Each threaded insert 70 may be torqued to a select preload such that the respective threaded insert 70 does not readily become loose during handling of the first powerplant component 64, mating the first powerplant component 64 with the second powerplant component 66 and/or disassembling the first powerplant component 64 from the second powerplant component 66 as described below. The insert shank 142 of FIG. 5 projects axially out from the respective first component insert aperture 90 and away from the first side 100 of the first component flange 86 to the shank distal end 152.

Referring to FIGS. 4 and 5, the first powerplant component 64 and the second powerplant component 66 are arranged together at a mechanical joint. The second component mount 110, for example, may be translated (e.g., slid) axially over the first component rim 84 until the second component flange 116 axially engages the first component mount 78 and its first component flange 86. The second component interior mating surface 128, for example, may axially abut against, axially contact and/or otherwise axially engage the first component interior mating surface 106. Each first component fastener aperture 88 of FIG. 4 is radially and circumferentially aligned with (e.g., coaxial with) a respective second component fastener aperture 118. Each first component insert aperture 90 and its mated threaded insert 70 of FIG. 5 are radially and circumferentially aligned with (e.g., coaxial with) a respective second component insert pocket 120. The insert head 140 of each threaded insert 70 may thereby be disposed within a respective second component insert pocket 120. Note, an axial depth of this second component insert pocket 120 is sized such that the insert head 140 does not axially engage the distal end 132 of the respective second component insert pocket 120.

Referring to FIG. 4, each fastener assembly 68 is mated with a respective set of the component fastener apertures 88 and 118 to secure the first powerplant component 64 and the second powerplant component 66 together. Each fastener assembly 68 of FIG. 4, for example, includes a fastener 154 (e.g., a bolt) and a nut 156. The fastener 154 of FIG. 4 includes a fastener head 158 and a fastener shank 160 connected to (e.g., formed integral with or otherwise attached to) the fastener head 158. The fastener head 158 may be axially abutted against, axially contact and/or otherwise axially engage the first component mount 78 and its first component flange 86 (or alternatively the second component mount 110 and its second component flange 116). The fastener shank 160 projects axially out from the fastener head 158, and may extend sequentially through a respective first component fastener aperture 88 and an aligned second component fastener aperture 118, to a distal end 162 of the fastener 154 and its fastener shank 160. The nut 156 is mounted (e.g., threaded) onto the fastener shank 160 at its distal end 162 and tightened to clamp the first component mount 78 and the second component mount 110 together between the fastener head 158 and the nut 156.

Following the securing of the first powerplant component 64 to the second powerplant component 66, each of the fastener apertures 88, 118 of FIG. 4 receives (e.g., is plugged by) a respective one of the fasteners 154. By contrast, each threaded insert bore 144 of FIGS. 3 and 5 may be open; e.g., empty. Each threaded insert bore 144 may also remain open during operation of the aircraft powerplant 20 and its engine system 24 of FIG. 1 or 2. In addition, each first component insert aperture 90 of FIG. 5 as well as each threaded insert 70 of FIG. 5 and its threaded insert bore 144 is radially and circumferentially overlapped (e.g., covered) by the second component mount 110 and its members 116 and 128. Here, the insert head 140 of each threaded insert 70 is disposed and captured axially between the first component mount 78 and the second component mount 110.

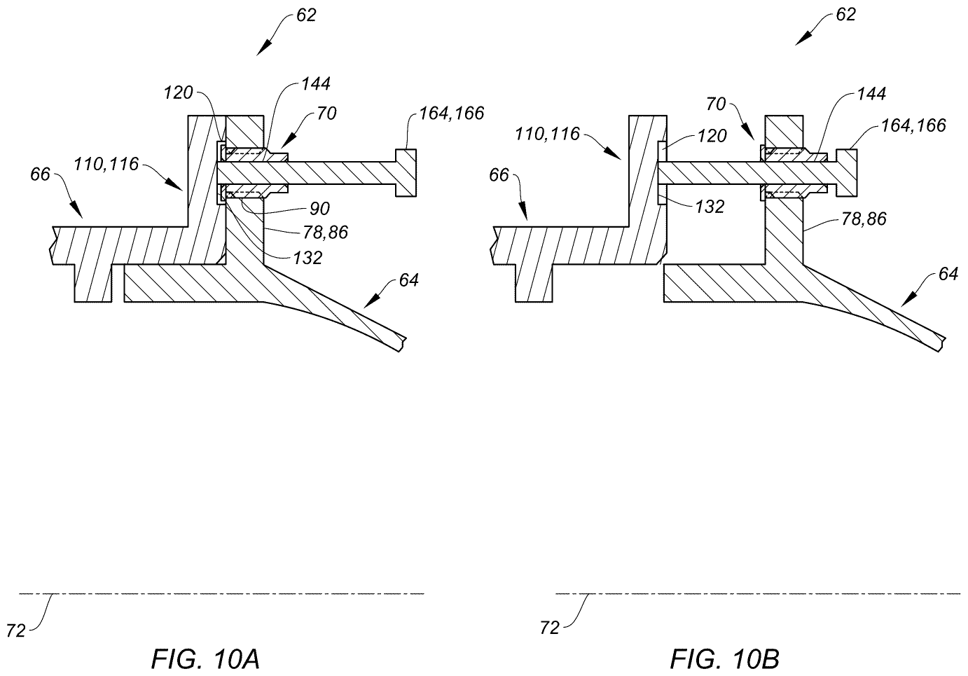

While each threaded insert bore 144 may remain open during aircraft powerplant operation, each threaded insert bore 144 of FIGS. 10A and 10B may be mated with (e.g., receive) a respective tool 164 during disassembly of the stationary structure 62; e.g., when the first powerplant component 64 is detached from the second powerplant component 66, or vice versa. Each tool 164 may be configured as a jacking device. Each tool 164 of FIG. 10A, for example, is configured as a bolt 166 which is threaded into the respective threaded insert bore 144. Each bolt 166 may be threaded until a distal end of a shank of the bolt 166 axially contacts and/or otherwise axially engages the second component mount 110 and its members 110 and 116. After removal of the fastener assemblies 68, each bolt 166 of FIG. 10B may continue to be threaded into the respective threaded insert 70 and its threaded insert bore 144 to press the second component mount 110 axially away from the first component mount 78 until, for example, the second powerplant component 66 is disengaged from the first powerplant component 64. Note, as each bolt 166 is threaded into the respective threaded insert 70, the rotation of the bolt 166 will tighten the respective threaded insert 70 further into the respective first component threaded aperture 90.

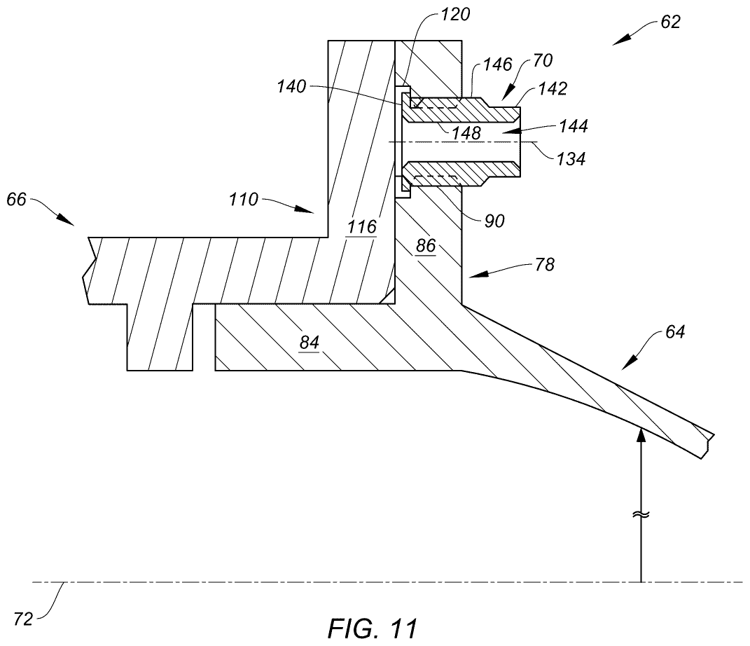

In some embodiments, referring to FIG. 5, the insert pockets 120 are configured with the second component mount 110 and its second component flange 116. In other embodiments, referring to FIG. 11, the insert pockets 120 may alternatively (or also) be configured with the first component mount 78 and its first component flange 86.

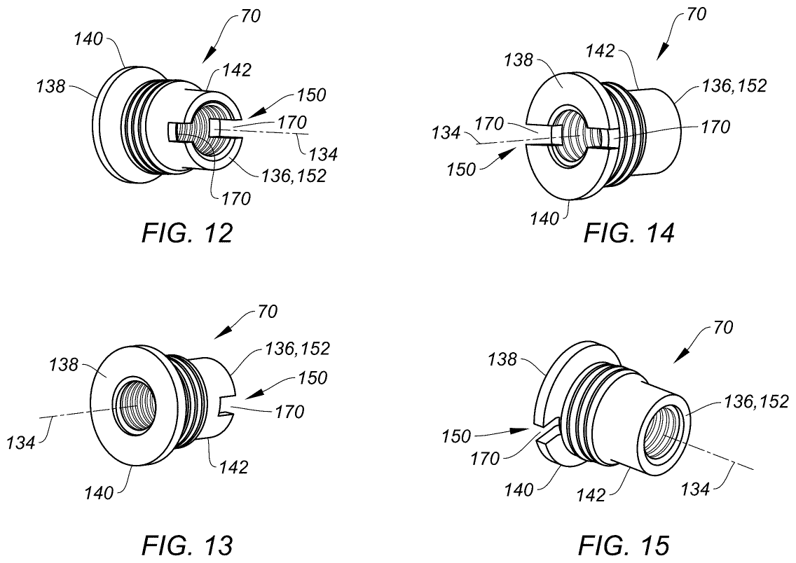

In some embodiments, referring to FIGS. 8 and 9, the wrenching feature 150 may be formed by one or more flats 168 (e.g., side surfaces forming the hexagonal shaped outer peripheral geometry) around the outer periphery of the insert head 140. The present disclosure, however, is not limited to such an exemplary type of wrenching feature. The wrenching feature 150 of FIGS. 12-15, for example, is formed by one or more aligned slots 170 in the respective threaded insert 70. The wrenching feature 150 of FIGS. 12 and 13 and its slots 170 are disposed at the insert first end 136/the shank distal end 152. The wrenching feature 150 of FIGS. 14 and 15 and its slots 170 are disposed at the insert second end 138/the insert head 140.

The first powerplant component 64 and the second powerplant component 66 are described above as engine cases for ease of description. The present disclosure, however, is not limited to such an exemplary arrangement. One or both of the first powerplant component 64 and/or the second powerplant component 66, for example, may each alternatively be configured as another component of the stationary structure 62 such as, but not limited to, an internal support structure. Examples of the internal support structure include, but are not limited to, a bearing support structure, a frame, a mid-turbine case, a vane array, etc.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. An assembly for a powerplant, comprising:
a first powerplant component including a first component mount and a plurality of first component apertures, the plurality of first component apertures arranged circumferentially about an axis and extending axially through the first component mount, and the plurality of first component apertures including a plurality of first component fastener apertures and a first component insert aperture;
a second powerplant component including a second component mount and a plurality of second component fastener apertures, each of the plurality of second component fastener apertures aligned with a respective one of the plurality of first component fastener apertures;
a plurality of fasteners attaching the first component mount and the second component mount together, each of the plurality of fasteners mated with a respective one of the plurality of first component fastener apertures and a respective one of the plurality of second component fastener apertures; and
an insert threaded into the first component insert aperture, the insert comprising a threaded bore and a head, the head disposed axially outside of the first component insert aperture.

2. The assembly of claim 1, wherein the threaded bore is configured to be empty during powerplant operation.

3. The assembly of claim 1, wherein
the second component mount comprises a second component mating surface radially and circumferentially overlapping the threaded bore; and
each of the plurality of second component fastener apertures projects into the second component mount from the second component mating surface.

4. The assembly of claim 3, wherein
the first component mount comprises a first component mating surface axially engaging the second component mating surface; and
each of the plurality of first component apertures projects into the first component mount from the first component mating surface.

5. The assembly of claim 1, wherein the second component mount radially and circumferentially covers the threaded bore.

6. The assembly of claim 1, wherein the first component mount axially contacts the second component mount.

7. The assembly of claim 1, wherein the first component mount radially contacts the second component mount.

8. The assembly of claim 1, wherein the insert includes
exterior threads threaded into the first component insert aperture, the exterior threads configured with a first rotational thread direction about a centerline axis of the insert; and
interior threads along the threaded bore, the interior threads configured with a second rotational thread direction about the centerline axis of the insert that is opposite the first rotational thread direction.

9. The assembly of claim 1, wherein
the head is abutted axially against the first component mount; and
the insert further includes a shank projecting out from the head to a distal end of the insert, the shank threaded into the first component insert aperture.

10. The assembly of claim 9, wherein the head is disposed axially between the first component mount and the second component mount.

11. The assembly of claim 9, wherein the head is seated in a pocket in the first component mount.

12. The assembly of claim 9, wherein the head is disposed in a pocket in the second component mount.

13. The assembly of claim 9, wherein the head comprises a wrenching feature.

14. The assembly of claim 9, wherein the shank comprises a wrenching feature.

15. The assembly of claim 1, wherein each of the plurality of first component fastener apertures is an unthreaded through-hole.

16. The assembly of claim 1, wherein each of the plurality of second component fastener apertures is an unthreaded through-hole.

17. The assembly of claim 1, wherein each of the plurality of fasteners includes
a second head abutted axially against the first component mount; and
a shank projecting axially out from the second head, through a respective one of the plurality of first component fastener apertures and a respective one of the plurality of second component fastener apertures, to a distal end of the shank;
the shank mated with a nut at the distal end of the shank, and the nut abutted axially against the second component mount.

18. The assembly of claim 1, wherein
the powerplant comprises an aircraft engine;
the first powerplant component comprises a first engine case; and
the second powerplant component comprises a second engine case.

19. An assembly for a powerplant, comprising:
a first powerplant component including a first flange and a plurality of first component apertures, the plurality of first component apertures arranged circumferentially about an axis and extending axially through the first flange, and the plurality of first component apertures including a plurality of first component fastener apertures and a first component insert aperture;
a second powerplant component including a second flange and a plurality of second component fastener apertures, the second flange axially engaging the first flange, and each of the plurality of second component fastener apertures aligned with a respective one of the plurality of first component fastener apertures;
a plurality of fasteners attaching the first flange and the second flange together, each of the plurality of fasteners comprising a first shank projecting axially through a respective one of the plurality of first component fastener apertures and a respective one of the plurality of second component fastener apertures; and
an insert projecting axially through the first component insert aperture and fixed to the first flange through a threaded interface, the insert comprising a threaded bore and a second shank, the threaded bore extending axially through the insert, and the second shank extending through the first component insert aperture and axially projecting out of the first component insert aperture opposite to the second flange.

20. An apparatus for a turbine engine, comprising:
a jacking insert including a head, a shank, a bore, exterior threads and interior threads;
the shank comprising an exterior threaded portion and an exterior unthreaded portion, the shank projecting axially along a centerline axis of the jacking inserted out from the head to a distal end of the jacking insert, the exterior unthreaded portion at the distal end of the jacking insert and the exterior threaded portion between the exterior unthreaded portion and the head;
the bore projecting axially along the centerline axis through the head and the shank;
the exterior threads arranged along an the exterior threaded portion of the shank, and the exterior threads configured with a first rotational thread direction about the centerline axis of the insert; and
the interior threads arranged along the bore, and the interior threads configured with a second rotational thread direction about the centerline axis of the insert that is opposite the first rotational thread direction.
